(19) United States
(12) Patent Application Publication
(10) Pub. No.: US 2011/0277790 A1
(43) Pub. Date: Nov. 17, 2011

(54) PROCESS FOR REMOVING WATER

(75) Inventors: Mai Hashimoto, Tokyo (JP); Masaaki Tsuzaki, Tokyo (JP)

(73) Assignee: ASAHI GLASS COMPANY, LIMITED, Tokyo (JP)

(21) Appl. No.: 13/189,638

(22) Filed: Jul. 25, 2011

Related U.S. Application Data
(63) Continuation of application No. PCT/JP10/51636, filed on Feb. 4, 2010.

(30) Foreign Application Priority Data
Feb. 9, 2009 (JP) 2009-027304

(51) Int. Cl. B08B 3/04

(52) U.S. Cl. 134/12

(57) ABSTRACT

To provide a process for removing water, which is free from formation of stains due to transfer of an article among dipping sumps, with which the water removal performance will not be decreased even for an article having a complicated shape, which can suppress suspension of water in a water removal solvent in a dipping sump, and which can maintain stable water removal performance continuously for a long period of time only with one dipping sump.

A process for removing water from an article, which comprises using a fluorinated solvent containing an alcohol as a water removal solvent, bringing the water removal solvent in a dipping sump to a boiling state, condensing vapor of the water removal solvent at an upper portion of the dipping sump, removing the water from the condensed water removal solvent outside the dipping sump and then returning the water removal solvent to the dipping sump, dipping an article having water attached in the water removal solvent in a boiling state in the dipping sump to remove water and then withdrawing the article.

### TECHNICAL FIELD

The present invention relates to a process for removing water to remove water on the surface of articles such as lenses, components of liquid crystal display devices, electronic parts, precision mechanical parts, in the precision components industry, the optomechanical industry, the electrical and electric industry, the plastic industry, etc. In this specification, removing water means to remove water from an article having the water attached and includes such operation modes as draining, dewatering and drying.

### BACKGROUND ART

In the precision mechanical industry, the optomechanical industry, the electrical and electric industry, the plastic industry, etc., lenses, components of liquid crystal display devices, electronic parts and precision mechanical parts are washed with water at the time of a plating step or a polishing step for example. On that occasion, if water is attached after the washing with water, in the next step will be impaired in many cases. Further, stains formed by remaining water sometimes lead to a decrease in the quality of a product such as bonding/welding failure in the next step, a defect on appearance, formation of rust, etc. Accordingly, it is necessary to completely remove water from the surface of the article by removing water and drying.

As a method for removing water from and drying such an article, a method is known wherein the article to be cleaned is dipped in a solvent capable of removing water from the surface of the article to be cleaned, and after withdrawing it, the solvent is dried. As the solvent to be employed in this method, an alcohol such as ethanol or isopropyl alcohol is known. However, such an alcohol is a compound having a flash point, and accordingly, it was required to consider the working environment such as fire prevention measures, and to the method of use. Further, as the above solvent, a solvent composition having a surfactant or the like added to a chlorinated solvent or a solvent composition having an alcohol or a surfactant added to a fluorinated solvent has been proposed. As a fluorinated solvent, a chlorofluorocarbon (hereinafter sometimes referred to as CFC), a perfluorocarbon (hereinafter sometimes referred to as PFC), a hydrochlorofluorocarbon (hereinafter sometimes referred to as HCFC), a hydrofluorocarbon (hereinafter sometimes referred to as HFC), a hydrofluoroether (hereinafter sometimes referred to as HFE), etc. have been used. Among them, PFC, which contains no chlorine, does not destroy the ozone layer of the earth, and thus its use is not phased out under the Montreal Protocol. However, due to its chemical stability and its long life in the atmosphere, it is considered to have high global warming potential (GWP), and its use is phased out. A chlorinated solvent, whose life in the atmosphere is short, does not reach the stratosphere to destroy the ozone layer, but its decomposition will take long in the ground water or in the ground, and accordingly the effluent criterion is set by the Japanese law of Water Pollution Control Act and Soil Contamination Countermeasures Act. Further, its atmospheric release to the atmosphere is restricted since it is a volatile organic compound (VOC), and accordingly when the chlorinated solvent is used, countermeasures against leakage and atmospheric release are required.

The above solvent composition having an alcohol added to the fluorinated solvent shows good water removal performance at the initial stage, but has a problem that when it is used continuously for a long period, the amount of water in the solvent composition is increased and exceeds the saturated solubility, and the precipitated water is suspended in the solvent composition. This is considered to be because water precipitated in the solvent composition is in a suspended state by forcible stirring. For example, for the purpose of removing water in a short time when the article to be cleaned is dipped in the solvent composition, a method of forcibly stirring water by ultrasonic cleaning, vibration cleaning or jet cleaning, or for the purpose of removing water surfaced to the liquid surface in the dipping sump, a means to recycle the solvent composition may be provided, and it is considered that water is in a suspended state in such cases. If the proportion of water suspended in the solvent composition becomes large, water tends to remain or water tends to be attached again on the surface of the article, thus leading to a problem of formation of stains on the article after drying. It is difficult to remove stains formed by attachment of water e.g. by washing in many cases.

As a method of resolving suspension of the water in the dipping sump, a method of permitting the solvent composition containing the water at an upper portion of the dipping sump to overflow into a water separation sump for removal has been known. In this method, the solvent composition containing the water is separated into the solvent composition and the water by a specific gravity separation method in the water separation sump, and the solvent composition is returned to the dipping sump. Further, Patent Document 1 discloses a draining method comprising a filtration step by e.g. a coalescer type filter to further separate the water remaining in the solvent composition after the solvent composition is subjected to specific gravity separation in the water separation sump.

In the above method, the solvent composition sent to the dipping sump after the water separation is always in a saturated water state, and it will easily be in a suspended state when the saturated water concentration of the solvent composition is reduced by the liquid temperature decrease of the solvent composition in the dipping sump, and accordingly the water removal performance may be decreased.

As a draining/drying method using a boiling bath, Patent Document 2 discloses a method and apparatus for draining/drying an article, which comprises dipping an article having water attached in a liquid of a solvent composition comprising PFC, applying ultrasonic waves to the article to remove the water attached to the article to remove the water from the article, then withdrawing this article from the liquid and transferring it to a boiling liquid of the solvent composition comprising PFC to remove the water remaining on the above article in the boiling liquid, and further transferring the article from the boiling liquid to vapor of the solvent composition comprising PFC to dry the article in the vapor, and then recovering and recycling the vapor of the solvent composition comprising PFC. Further, Patent Document 3 discloses a draining/drying method carrying out the draining/drying step similar to Patent Document 2 by using a chlorinated organic solvent containing a stabilizer and a surfactant at from 5 to 50° C.

In Patent Documents 2 and 3, the article is dipped in a ultrasonic dipping sump to remove the water attached to the article to drain the water from the article, and then the article is further dipped in a boiling liquid sump to remove the remaining water or a surfactant or the like, and then the article is dried in vapor. In this method, at least two sumps in which the article is dipped are required. Further, when the article is transferred from the ultrasonic dipping sump to the boiling liquid sump, the article on which the water remains may be dried to form stains. Stains once formed in the draining step are likely to be unremovable. Further, by the ultrasonic dipping, the water removal performance is sometimes deteriorated depending on the shape and the type of the article. A method of stirring the water removal solvent to maintain the water removal performance or simultaneously vibrating the article may be mentioned, but no sufficient water removal performance will be obtained in the case of an article having a complicated shape such as having fine pores or gaps. Further, ultrasonic application may cause damages to the article such as breakage or scars. Further, as described above, PFC and a chlorinated solvent are solvents harmful to the environment.

Further, Patent Document 4 discloses a water removal method of jetting a pressurized and superheated water removal solvent to an article dipped in a water removal solvent in a water removal sump to form explosible collision force and turbulence by the boiling state in the air thereby to remove the water on the article. In this method, the water removed from the article and surfaced to the liquid surface flows down from the water removal sump to a water separation sump together with the water removal solvent by the pressurized and superheated water removal solvent.

In Patent Document 4, the pressurized and superheated solvent may not be in contact with the entire article depending on the shape of the article. Further, even though only one sump is required for dipping, it is essential to dispose a water separation sump to receive the water removed from the article and overflowed from the dipping sump to separate the water from the water removal solvent, next to the dipping sump, which is one of restrictions for preparation of the apparatus.

### PRIOR ART DOCUMENTS

### Patent Documents

Patent Document 1: WO2005-079943

Patent Document 2: JP-A-5-114594

Patent Document 3: JP-A-3-114501

Patent Document 4: JP-A-2004-249250

### DISCLOSURE OF INVENTION

### Technical Problem

It is an object of the present invention to provide a process for removing water, which is free from formation of stains due to transfer among dipping sumps, with which the water removal performance will not be decreased even for an article having a complicated shape, which can suppress suspension of water in a water removal solvent in a dipping sump, and which can maintain stable water removal performance continuously for a long period of time only with one dipping sump.

### Solution to Problem

That is, the present invention provides the following process for removing water from an article.
[1] A process for removing water from an article, which comprises using a fluorinated solvent containing an alcohol as a water removal solvent, dipping an article having water attached in a liquid of the water removal solvent to dissolve or disperse the water in the water removal solvent and remove it from the article, withdrawing the article from the liquid of the water removal solvent and drying it to remove the water from the article having water attached, wherein the water removal solvent in a dipping sump in which the water removal solvent is stored is brought to a boiling state, a cooling means to condense vapor of the water removal solvent is provided at an upper portion of the dipping sump and the condensed water removal solvent is sent out of the dipping sump, a water removal solvent containing water at a concentration less than the saturated water concentration at the boiling temperature of the water removal solvent or containing no water is introduced to the dipping sump, and the article having water attached is dipped in the liquid of the water removal solvent in a boiling state in the dipping sump to remove water, and then the article is withdrawn from the liquid of the water removal solvent.
[2] The process for removing water according to the above [1], wherein the amount of the condensed water removal solvent sent out is adjusted so that the water concentration contained in the water removal solvent boiling in the dipping sump is at most the saturated water concentration at the boiling temperature when the article is withdrawn, and the amount of the water removal solvent introduced to the dipping sump is adjusted to be substantially equal to the amount of the water removal solvent sent out.
[3] The process for removing water according to the above [1] or [2], wherein the water removal solvent sent out of the dipping sump is introduced to a water separation sump, the water is separated from the water removal solvent in the water separation sump by a specific gravity separation method, the separated water is discharged from the water separation sump, and the water removal solvent from which the water is separated is introduced from the water separation sump to the dipping sump as the water removal solvent containing water at a concentration less than the saturated water concentration.
[4] The process for removing water according to the above [3], wherein the temperature (T) of the water removal solvent in the water separation sump is T^{b}−10<T<T^{b} (wherein T^{b} is the boiling point of the water removal solvent).
[5] The process for removing water according to any one of the above [1] to [4], wherein the fluorinated solvent is a hydrofluoroether or a hydrofluorocarbon.
[6] The process for removing water according to any one of the above [1] to [4], wherein the fluorinated solvent is at least one hydrofluoroether selected from the group consisting of 1,1,2,2-tetrafluoroethyl-2,2,2-trifluoroethylether, (perfluorobutoxy)methane and (perfluorobutoxy)ethane.
[7] The process for removing water according to any one of the above [1] to [4], wherein the fluorinated solvent is at least one hydrofluorocarbon selected from the group consisting of 1,1,1,2,2,3,3,4,4,5,5,6,6-tridecafluorohexane, 1,1,1,3,3-pentafluorobutane and 1,1,1,2,2,3,4,5,5,5-decafluoropentane.
[8] The process for removing water according to any one of the above [1] to [7], wherein the alcohol is a C₁₋₃ alkanol.
[9] The process for removing water according to any one of the above [1] to [8], wherein the content of the alcohol in the water removal solvent is from 3 to 15 mass %.

[10] The process for removing water according to any one of the above [1] to [9], wherein the water removal solvent is an azeotropic composition of the alcohol and the fluorinated solvent.

### Advantageous Effects of Invention

According to the present invention, water removal can be carried out without formation of stains due to transfer among dipping sumps, by dipping an article having water attached to one dipping sump in which a water removal solvent in a boiling state is stored, withdrawing the article and drying it. Further, by the water removal solvent in the dipping sump being in a boiling state, the water removed from the article is evaporated together with the water removal solvent to remove the water from the dipping sump, whereby it is possible to prevent the water in the water removal solvent from being in a suspended state. Further, by always removing the water, stable water removal performance can be maintained continuously for a long period of time.

### BRIEF DESCRIPTION OF DRAWINGS

FIG. 1 is a schematic view illustrating an apparatus used in a water removal test employing the process for removing water of the present invention.

FIG. 2 is a schematic view illustrating an apparatus used in a water removal test disclosed in Patent Document 1.

FIG. 3 is a graph illustrating a change with time of the water concentration in a water removal solvent in a dipping sump in Example 5.

### DESCRIPTION OF EMBODIMENTS

In the present invention, the water removal solvent comprises a fluorinated solvent containing an alcohol, and it contains water removed from the article when used. Further, the water removal solvent may be a fluorinated solvent containing a small amount of other components in addition to the alcohol.

The fluorinated solvent in the present invention is preferably a hydrofluoroether or a hydrofluorocarbon. However, the fluorinated solvent is not limited thereto, and it may be another fluorinated solvent. The fluorinated solvent other than the hydrofluoroether or the hydrofluorocarbon may be a perfluorocarbon or a hydrochlorofluorocarbon. The fluorinated solvent is preferably flame retardant or nonflammable.

The hydrofluoroether is preferably a compound represented by the formula 1:

R¹—O—R² Formula 1

In the above formula, each of R¹ and R² which are independent of each other, is an alkyl group or a fluorinated alkyl group. The total number of fluorine atoms contained in R¹ and R² is not 0, the total number of hydrogen atoms contained in R¹ and R² is at least 1, and the total number of carbon atoms contained in R¹ and R² is from 4 to 8. When the total number of carbon atoms contained in R¹ and R² is m, the total number of fluorine atoms contained in R¹ and R² is preferably at least m+1, more preferably at least m+3. Such a hydrofluoroether having a large number of fluorine atoms tends to be flame retardant or nonflammable.

Particularly, the hydrofluoroether is preferably 1,1,2,2-tetrafluoroethyl-2,2,2-trifluoroethylether, (perfluorobutoxy)methane or (perfluorobutoxy)ethane, and they may be used alone or as a mixture of two or more.

The hydrofluorocarbon is a compound represented by CₙFₚH_{q} (wherein n is an integer of at least 3, p is an integer of at least 1, q is an integer of at least 1, and p+q is 2n+2 or 2n), and is an aliphatic hydrofluorocarbon when p+q is 2n+2, and is an alicyclic hydrofluorocarbon when p+q is 2n. n is preferably from 3 to 8, more preferably from 4 to 6. The number (p) of fluorine atoms is preferably at least n+1, more preferably at least n+3. Such a hydrofluorocarbon having a large number of fluorine atoms tends to be flame retardant or noncombustible.

The hydrofluorocarbon may, for example, be a compound represented by C₄F₅H₅, C₄F₆H₄, C₄F₇H₃, C₄F₈H₂, C₄F₉H, C₅F₆H₆, C₅F₇H₅, C₅F₈H₄, C₅F₉H₃, C₅F₁₀H₂, C₅F₁₁H, C₆F₇H₇, C₆F₈H₆, C₆F₉H₅, C₆F₁₀H₄, C₆F₁₁H₃, C₆F₁₂H₂ or C₆F₁₃H, or cyclic C₅F₇H₃.

As the hydrofluorocarbon, specifically, the following compounds may be mentioned.

1,1,1,3,3-pentafluorobutane, 1,1,2,3,4,4-hexafluorobutane, 2-methyl-1,1,1,3,3,3-hexafluoropropane, 1,2,2,3,3,4-hexafluorobutane, 1,1,1,2,3,3,4-heptafluorobutane, 1,1,2,2,3,4,4-heptafluorobutane, 1,1,1,2,3,4,4-heptafluorobutane, 1,1,2,2,3,3,4-heptafluorobutane, 1,1,1,2,3,3,4,4-octafluorobutane, 1,1,1,2,2,3,3,4-octafluorobutane, 1,1,2,2,3,3,4,4-octafluorobutane, 1,1,1,2,2,3,3,4,4-nonafluorobutane, 1,1,1,2,2,3,4,4,4-nonafluorobutane.

1,1,2,3,3,4,5,5-octafluoropentane, 1,1,1,2,2,5,5,5-octafluoropentane, 1,1,2,2,3,3,4,4,5-nonafluoropentane, 1,1,1,2,3,3,4,4,5-nonafluoropentane, 1,1,1,2,2,4,5,5,5-nonafluoropentane, 1,1,1,2,2,3,5,5,5-nonafluoropentane, 1,1,1,2,3,3,4,4,5,5-decafluoropentane, 1,1,1,2,2,3,3,4,5,5-decafluoropentane, 1,1,1,2,2,3,4,5,5,5-decafluoropentane, 1,1,1,2,2,4,4,5,5,5-decafluoropentane, 1,1,1,2,2,3,3,4,4,5,5-undecafluoropentane, 1,1,1,2,2,3,3,4,5,5,5-undecafluoropentane, 1,1,1,2,2,3,3,4,4-nonafluorohexane.

2-trifluoromethyl-1,1,1,2,4,4-hexafluorobutane, 1,1,1,2,2,5,5,6,6,6-decafluorohexane, 2-trifluoromethyl-1,1,1,3,4,5,5-heptafluoropentane, 2-trifluoromethyl-1,1,1,2,3,4,5-heptafluoropentane, 2-trifluoromethyl-1,1,1,2,3,3,4,4-octafluorobutane, 2-trifluoromethyl-1,1,1,3,4,5,5,5-nonafluoropentane, 2-trifluoromethyl-1,1,1,2,3,4,5,5-octafluoropentane, 2-trifluoromethyl-1,1,1,2,3,5,5,5-octafluoropentane.

1,1,2,2,3,3,4,4,5,5,6,6-dodecafluorohexane, 2-trifluoromethyl-1,1,1,3,4,4,5,5,5-nonafluoropentane, 2-trifluoromethyl-1,1,1,2,3,4,5,5,5-nonafluoropentane, 1,1,1,2,2,3,3,4,4,5,5,6,6-tridecafluorohexane, 1,1,1,2,2,3,3,4,4,5,6,6,6-tridecafluorohexane, 1,1,2,2,3,3,4-heptafluorocyclopentane.

Among them, the hydrofluorocarbon is preferably 1,1,1,3,3-pentafluorobutane, 1,1,1,2,2,3,4,5,5,5-decafluoropentane, 1,1,1,2,2,3,3,4,4-nonafluorohexane, 2-trifluoromethyl-1,1,1,2,3,4,5,5,5-nonafluoropentane, or 1,1,1,2,2,3,3,4,4,5,5,6,6-tridecafluorohexane, and they may be used alone or as a mixture of two or more.

The content of the fluorinated solvent in the water removal solvent in the present invention is preferably from 80 to 99 mass %, more preferably from 85 to 97 mass %.

As the alcohol, allyl alcohol or an alkanoyl may, for example, be used. Among them, a C₁₋₃ alkanol is preferred, and methanol, ethanol or isopropyl alcohol is particularly preferred. They may be used alone or as a mixture of two or more.

In the present invention, if the content of the alcohol in the water removal solvent is too low, the solubility of water in the water removal solvent tends to be decreased, and it tends to be difficult to remove water from the surface of an article having the water attached on its surface, when the article is dipped in the water removal solvent. Thus, the water tends to remain on the surface when the article is withdrawn, thus leading for formation of stains.

On the other hand, if the content of the alcohol in the water removal solvent is too high, the water removal solvent tends to be a composition having a flash point, whereby its handling tends to be cumbersome. Further, the concentration of the alcohol contained in the water separated from the water removal solvent tends to be high, and at the same time the content of the alcohol in the water removal solvent tends to decrease, whereby it tends to be difficult to maintain the water removal performance. Further, if the concentration of the alcohol contained in the water to be separated from the water removal solvent and discharged becomes high, the load for the treatment of the water also increases. From such a viewpoint, the content of the alcohol in the water removal solvent in the present invention is preferably from 1 to 20 mass %, particularly preferably from 3 to 15 mass %.

Further, with respect to the content of the alcohol, in a case where the hydrofluoroether or the hydrofluorocarbon and the alcohol will form an azeotropic composition, it is possible to control the compositional change during evaporation. Accordingly, it is most preferred to employ such an azeotropic composition as the water removal solvent. Further, an azeotropic-like composition can also be used as the water removal solvent.

Specific examples preferred as the water removal solvent in the present invention will be shown in Table 1. The water removal solvents shown in Table 1 are azeotropic compositions of an alcohol and a fluorinated solvent, and their compositions and azeotropic points are shown.

TABLE 1

| | Azeotropic |
|---|---|
| Composition of water removal solvent | temperature |
| mass % in bracket ( ) | (° C.) |
| 1,1,1,2,2,3,4,5,5,5-Decafluoropentane (94)/methanol (6) | 48 |
| 1,1,1,2,2,3,4,5,5,5-Decafluoropentane (96)/ethanol (4) | 52 |
| 1,1,1,2,2,3,4,5,5,5-Decafluoropentane (97)/2-propanol (3) | 52 |
| 1,1,1,2,2,3,3,4,4-Nonafluorohexane (88)/methanol (12) | 49 |
| 1,1,1,2,2,3,3,4,4-Nonafluorohexane (91)/ethanol (9) | 58 |
| 1,1,1,2,2,3,3,4,4-Nonafluorohexane (90)/2-propanol (10) | 60 |
| 1,1,1,2,2,3,3,4,4,5,5,6,6-Tridecafluorohexane (89)/methanol (11) | 52 |
| 1,1,1,2,2,3,3,4,4,5,5,6,6-Tridecafluorohexane (91)/ethanol (9) | 61 |
| 1,1,1,2,2,3,3,4,4,5,5,6,6-Tridecafluorohexane (91)/2-propanol (9) | 64 |
| 1,1,2,2-Tetrafluoroethyl-2,2,2-trifluoroethyl ether (92)/methanol (8) | 46 |
| 1,1,2,2-Tetrafluoroethyl-2,2,2-trifluoroethyl ether (94)/ethanol (6) | 54 |
| 1,1,2,2-Tetrafluoroethyl-2,2,2-trifluoroethyl ether (96)/2-propanol (4) | 55 |
| (Perfluorobutoxy)methane (95)/2-propanol (5) | 55 |

To the fluorinated solvent in the present invention, other components other than the alcohol may be contained depending upon various purposes. For example, in order to increase the solubility or to control the evaporation speed, an organic solvent (hereinafter referred to as another organic solvent) other than the fluorinated solvent and the alcohol may further be contained.

As such another organic solvent, at least one member selected from the group consisting of hydrocarbons, ketones, ethers containing no halogen atoms, esters and halogenated hydrocarbons other than the hydrofluorocarbon, may be employed. If such other organic solvents are contained, the contents of such other organic solvents are preferably contents at which the purpose can be achieved within a range not to impair the water removal performance of the water removal solvent, and specifically from 1 to 20 mass %, particularly preferably from 2 to 10 mass %, in the water removal solvent.

As the hydrocarbons, C₅₋₁₅ linear or cyclic saturated or unsaturated hydrocarbons are preferred, such as n-pentane, 2-methylbutane, n-hexane, 2-methylpentane, 2,2-dimethylbutane, 2,3-dimethylbutane, n-heptane, 2-methylhexane, 3-methylhexane, 2,4-dimethylpentane, n-octane, 2-methylheptane, 3-methylheptane, 4-methylheptane, 2,2-dimethylhexane, 2,5-dimethylhexane, 3,3-dimethylhexane, 2-methyl-3-ethylpentane, 3-methyl-3-ethylpentane, 2,3,3-trimethylpentane, 2,3,4-trimethylpentane, 2,2,3-trimethylpentane, 2-methylheptane, 2,2,4-trimethylpentane, n-nonane, 2,2,5-trimethylhexane, n-decane, n-dodecane, 1-pentene, 2-pentene, 1-hexene, 1-octene, 1-nonene, 1-decene, cyclopentane, methylcyclopentane, cyclohexane, methylcyclohexane, ethylcyclohexane, bicyclohexane, cyclohexene, α-pinene, dipentene, decalin, tetralin and amylnaphthalene. More preferred is, for example, n-pentane, cyclopentane, n-hexane, cyclohexane or n-heptane.

The ketones are preferably C₃₋₉ linear or cyclic saturated or unsaturated ketones. Specifically, they include, for example, acetone, methyl ethyl ketone, 2-pentanone, 3-pentanone, 2-hexanone, methyl isobutyl ketone, 2-heptanone, 3-heptanone, 4-heptanone, diisobutyl ketone, mesityl oxide, phorone, 2-octanone, cyclohexanone, methylcyclohexanone, isophorone, 2,4-pentanedione, 2,5-hexanedione, a diacetone alcohol and acetophenone. More preferred is, for example, acetone or methyl ethyl ketone.

The ethers containing no halogen atoms are preferably C₂₋₅ linear or cyclic saturated or unsaturated ethers, such as diethyl ether, dipropyl ether, diisopropyl ether, dibutyl ether, ethyl vinyl ether, butyl vinyl ether, anisole, phenetole, methylanisole, dioxane, furan, methylfuran and tetrahydrofuran. More preferred is, for example, diethyl ether, diisopropyl ether, dioxane or tetrahydrofuran.

The esters are preferably C₂₋₁₉ linear or cyclic saturated or unsaturated esters. Specifically, they include, for example, methyl formate, ethyl formate, propyl formate, butyl formate, isobutyl formate, pentyl formate, methyl acetate, ethyl acetate, propyl acetate, isopropyl acetate, butyl acetate, isobutyl acetate, sec-butyl acetate, pentyl acetate, methoxybutyl acetate, sec-hexyl acetate, 2-ethylbutyl acetate, 2-ethylhexyl acetate, cyclohexyl acetate, benzyl acetate, methyl propionate, ethyl propionate, butyl propionate, methyl butyrate, ethyl butyrate, butyl butyrate, isobutyl isobutyrate, ethyl 2-hydroxy-2-methylpropionate, methyl benzoate, ethyl benzoate, propyl benzoate, butyl benzoate, benzyl benzoate, γ-butyrolactone, diethyl oxalate, dibutyl oxalate, dipentyl oxalate, diethyl malonate, dimethyl maleate, diethyl maleate, dibutyl maleate, dibutyl tartarate, tributyl citrate, dibutyl sebacate, dimethyl phthalate, diethyl phthalate, and dibutyl phthalate. More referred is, for example, methyl acetate or ethyl acetate.

The halogenated hydrocarbons other than the hydrofluorocarbon, are preferably C₁₋₆ saturated or unsaturated chlorinated hydrocarbons, such as methylene chloride, 1,1-dichloroethane, 1,2-dichloroethane, 1,1,2-trichloroethane, 1,1,1,2-tetrachloroethane, 1,1,2,2-tetrachloroethane, pentachloroethane, 1,1-dichloroethylene, 1,2-dichloroethylene, trichloroethylene, tetrachloroethylene and 1,2-dichloropropane.

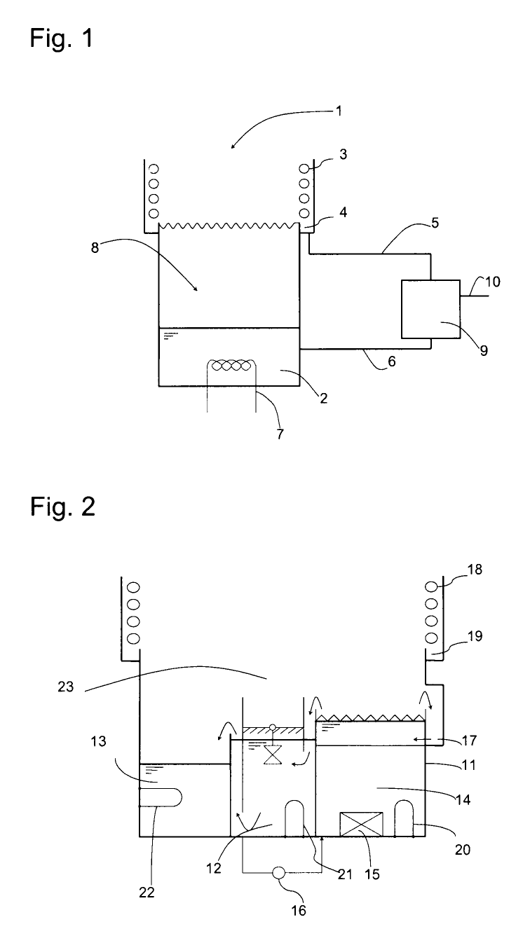

Now, the process for removing water of the present invention will be specifically described. FIG. 1 is a schematic view illustrating one example of an apparatus for removing water/drying to carry out the process of the present invention. A dipping sump 1 is an open-topped sump, and a water removal solvent 2 in a liquid state is stored therein. A cooling pipe 3 is provided on the inside wall at an upper portion of the dipping sump 1, the water removal solvent condensed on the surface of the cooling pipe 3 is collected in a trough 4 provided on the inside wall below the cooling pipe, and the collected water removal solvent is sent out of the dipping sump 1 from a sending-out pipe 5. On the other hand, into the dipping sump 1, a new water removal solvent is introduced through an introducing pipe 6. Here, the new water removal solvent is a water removal solvent having a water concentration lower than that of the water removal solvent sent out, and it may be one having the water concentration of the water removal solvent sent out adjusted, or a separate water removal solvent containing no water may be used. At the bottom of the dipping sump 1, a heater 7 is provided, and the water removal solvent 2 in the liquid state is kept in a boiling state by heating by the heater 7. A vapor zone 8 of the water removal solvent is formed above the water removal solvent 2 in a liquid state and below the height where the cooling pipe 3 is present.

As described above, the water removal solvent 2 in the dipping sump 1 is kept in a boiling state, and the evaporated water removal solvent forms the vapor zone 8, the vapor of the water removal solvent at an upper portion of the vapor zone 8 is cooled and condensed, and the condensed water removal solvent is sent out of the dipping sump 1 through the sending-out pipe 5. On the other hand, a new water removal solvent is introduced into the dipping sump 1 through the introducing pipe 6, and by keeping the amount of the new water removal solvent introduced to substantially the same as the amount of the condensed water removal solvent sent out, the amount of the water removal solvent 2 in the dipping sump 1 is kept in a stationary state. An article having water attached is dipped in the liquid of the water removal solvent 2 in the dipping sump 1 from the open top of the dipping sump 1, and the water attached to the article is dissolved or dispersed in the water removal solvent so that it is removed from the article. Then, the article is withdrawn from the water removal solvent 2, and is taken out from the dipping sump 1 through the vapor zone 8. The water removal solvent attached to the article withdrawn from the water removal solvent 2 is preferably evaporated and removed (dried) after the article is withdrawn from the vapor zone 8 until it passes by the cooling pipe 3 and is taken out from the top of the dipping sump 1.

The apparatus for removing water/drying to carry out the process of the present invention preferably further has a water separation sump 9. The water separation sump 9 is a sump to separate water from the water removal solvent by a specific gravity separation method, and in the sump, the water removal solvent in a liquid state containing precipitated water is left at rest, a layer of the water is formed over the liquid layer of the water removal solvent by the specific gravity difference, and water can be taken out from the layer of the water. To the water separation sump 9, the above sending-out pipe 5 is connected, the condensed water removal solvent is introduced into the water separation sump 9, and the separated water is discharged from the water separation sump 9 through a discharge pipe 10. On the other hand, the water removal solvent from which the water is separated is returned to the dipping sump 1 from the water separation sump 9 through the introducing pipe 6 connected to the water separation sump 9.

In the present invention, the temperature of the water removal solvent in a boiling state in the dipping sump is the boiling point of the water removal solvent. Here, in a case where the water removal solvent is an azeotropic composition or an azeotropic-like composition, the boiling point of the water removal solvent is the azeotropic point. Further, in a case where the water removal solvent is not an azeotropic composition, the boiling point is the temperature of the water removal solvent boiling in the dipping sump. Further, the azeotropic-like composition is generally a composition which has no true azeotropic point but the compositional change of which after evaporation and condensation are repeated, is negligible. In the present invention, it is a composition of which the compositional change after evaporation and condensation are repeated is within ±3% by the proportion of the alcohol (however, it is at least 1 mass % even in the case of one having a minimum proportion of the alcohol).

In the process for removing water from an article of the present invention, the article having water attached is dipped in the liquid of the water removal solvent in a boiling state stored in the dipping sump 1. Most of the water attached to the article is dissolved or dispersed in the water removal solvent from the article. During this dipping, the time required for removing water can be shortened by the flow of the water removal solvent in a boiling state. The time during which the article is dipped in the water removal solvent is usually preferably from 30 seconds to 10 minutes.

In order to keep the water content in the water removal solvent to at most the saturated water concentration, it is necessary to remove water in an amount equal to or larger than the amount of the water to be added to the water removal solvent per unit time, from the water removal solvent in the dipping sump. In the stationary state, the amount of water added to the water removal solvent and the water removed from the water removal solvent per unit time are equal. The water added to the water removal solvent is the water removed from the article dipped (further, water may sometimes be added to the water removal solvent from the environment). In the present invention, by sending the condensed water removal solvent from the dipping sump, the water accompanying the condensed water removal solvent is removed from the dipping sump. In order to keep the amount of the water removal solvent in the dipping sump substantially constant, the water removal solvent in an amount substantially equal to the amount of the condensed water removal solvent sent out is introduced into the dipping sump. The water removal solvent to be introduced is required to be a water removal solvent containing water at a concentration less than the saturated water concentration at the boiling temperature of the water removal solvent or a water removal solvent containing no water.

In the present invention, the concentration of the water in the vapor of the water removal solvent is higher than the concentration of the water in the water removal solvent in a boiling state. That is, the water removal solvent in the present invention has a property to be a vapor accompanied by the water in a larger amount than the saturated water amount in the boiling water removal solvent. The water in the vapor of the water removal solvent is sent out of the dipping sump as accompanying the condensed water removal solvent, whereby the water concentration in the boiling water removal solvent can be at most the saturated water concentration at least when the article is withdrawn. In order to keep the amount of the water in the water removal solvent to at most the saturated water concentration at least when the article is withdrawn (preferably constantly), the amount of water sent out of the dipping sump is adjusted depending on the amount of water added from the article. This adjustment is carried out by adjusting the amount of the condensed water removal solvent sent out. For example, in order to increase the amount of water sent out, e.g. a means of increasing the performance to heat the water removal solvent thereby to increase the evaporation amount and increasing the amount of condensation thereby to increase the amount of the condensed water removal solvent sent out, may be employed. It is more preferred to adjust the amount of the water in the water removal solvent so that the water concentration in the boiling water removal solvent is at most 90% of the saturated water concentration at the temperature (boiling point) of the water removal solvent.

In the present invention, as shown in FIG. 1, it is preferred that the water separation sump 9 is further provided, the water removal solvent sent out of the dipping sump is introduced in the water separation sump 9, the water is separated from the water removal solvent by the specific gravity separation method in the water separation sump 9, the separated water is discharged from the water separation sump 9, and the water removal solvent from which the water is separated is introduced into the dipping sump 1 from the water separation sump 9, as the water removal solvent containing the water at a concentration less than the saturated water concentration. In the water separation sump 9, the water removal solvent and the water are separated by the specific gravity separation method. Since the fluorinated solvent has a specific gravity greater than that of water and only a small amount of water is soluble in the fluorinated solvent, the water removal solvent having a low alcohol content will easily be separated from the water. When the water removal solvent containing the water introduced to the water separation sump 9 is left at rest, the water removal solvent is separated into an upper layer comprising the water in which the alcohol is dissolved and a lower layer comprising the water removal solvent. It is only necessary to leave the water removal solvent at rest usually for from about 1 to 30 minutes.

With a view to carrying out separation easily and quickly, the temperature of the water removal solvent in the water separation sump 9 is preferably at least a temperature lower by 10° C. than the boiling point of the water removal solvent, particularly preferably at least a temperature lower by 5° C. than the boiling point. That is, where the temperature of the water removal solvent in the water separation sump 10 is T and the boiling point of the water removal solvent is T^{b}, it is preferred that T^{b}−10≦T<T^{b}, particularly preferably T^{b}−5≦T<T^{b}. If the temperature of the water removal solvent in the water separation sump 9 is lower than (T^{b}−10), the water dissolved in the water removal solvent or the water dispersed in the form of fine particles is rapidly cooled to form a suspension state of the water in the water removal solvent. If suspension occurs, it will be difficult to separate the water removal solvent and the water by the specific gravity separation. Accordingly, the temperature of the water removal solvent in the water separation sump 9 is preferably adjusted within the above temperature range.

After the water removal solvent and water are separated into two layers in the water separation sump 9, the water in the upper layer is discharged from the water separation sump 9. The water discharged contains a very small amount of HFC or HFE in addition to the alcohol. Accordingly, the discharged water is preferably disposed of after the above components other than water are removed by means of e.g. distillation or pervaporation. Further, such components other than water may be recovered from the discharged water and reused.

In the water removal solvent in the lower layer after separation into two layers in the water separation sump 9, the water in a saturation amount of the water removal solvent at the temperature of the water separation sump 9 is contained. In general, the solubility of the water in a water removal solvent increases as the liquid temperature of the water removal solvent increases. Accordingly, by subjecting a mixture of the water removal solvent and the water to separation at a temperature lower than the boiling point of the water removal solvent in the water separation sump 9, the concentration of the water contained in the water removal solvent in the lower layer is at most the saturated water concentration of the water removal solvent in a boiling state.

As described above, the amount of the water contained in the water removal solvent in the lower layer in the water separation sump 9 is less than the amount of water of the saturated water concentration of the water removal solvent in a boiling state. Accordingly, the water removal solvent in the lower layer can be introduced into the dipping sump 1 from the water separation sump 9, as the water removal solvent containing the water at a concentration less than the saturated water concentration.

To the water removal solvent returned from the water separation sump to the dipping sump, an alcohol or a fluorinated solvent may be added for the component adjustment. For example, as described above, since an alcohol is contained in the water discharged from the water separation sump, the amount of the alcohol in the water removal solvent returned from the water separation sump to the dipping sump is smaller than the amount of the alcohol in the original water removal solvent, whereby the water removal performance may be decreased. Accordingly, it is preferred to add an alcohol in an amount to compensate for deficiency to the water removal solvent to be introduced to the dipping sump from the water separation sump. In a case where the water removal solvent contains another organic solvent in addition to the alcohol, as the case requires, such another organic solvent to make up for deficiency may be added in the same manner as the alcohol, to the water removal solvent to be introduced to the dipping sump from the water separation sump.

Further, since a part of the water removal solvent is brought when the article is taken out from the dipping sump, or a part of the water removal solvent sent out of the dipping sump flies off in e.g. the water separation sump in many cases, even when all the amount of the water removal solvent separated and sent out of the water separation sump is returned to the dipping sump, the amount is smaller than the water removal solvent sent out of the dipping sump, and the amount of the water removal solvent in the dipping sump may be reduced with time. Accordingly, in such a case, a new water removal solvent can be introduced into the dipping sump together with the water removal solvent separated and sent out of the water separation sump. This new water removal solvent may be introduced into the dipping sump separately from the water removal solvent separated and sent out of the water separation sump. Further, as the new water removal solvent, a water removal solvent containing substantially no water may be used.

Further, in the present invention, the water may further be removed from the water removal solvent sent out of the water separation sump, before it is returned to the dipping sump. For example, the water removal solvent may be subjected to filtration through a coalescer type filter to further remove the water. In such a case, a coalescer type filtration type water separation apparatus is disposed between the water separation sump and the dipping sump, the water removal solvent discharged from the water separation sump is subjected to the filtration separation apparatus to further remove the water, and the water removal solvent having a smaller water amount discharged from the filtration type water separation apparatus is returned to the dipping sump.

In the present invention, the method of removing the water from the water removal solvent sent out of the dipping sump is not limited to the above-mentioned specific gravity separation method using the separation sump, For example, the water can be removed from the water removal solvent by the above-mentioned coalescer type filtration type water separation apparatus. In this case also, the water removal solvent from which the water is removed is preferably returned to the dipping sump as the water removal solvent containing the water at a concentration less than the above saturated water concentration.

In the present invention, in a case where the water is removed from the water removal solvent by circulating the water removal solvent among the dipping sump and the water separation sump and the like, the circulating time of the water removal solvent is not particularly limited, but is preferably from 1 minute to 2 hours, more preferably from 30 minutes to 1 hour. If the circulating time is too short, the energy required for heating for boiling or for cooling for condensation tends to be enormous, and further, separation of the water from the water removal solvent in the water separation sump will be difficult. Further, if the circulating time is too long, the water removal amount per unit time from the water removal solvent tends to be small, it tends to be difficult to sufficiently remove the water brought as attached to the article, and the water removal treatment efficiency tends to be decreased.

The article which is dipped in the liquid of the water removal solvent in a boiling state in the dipping sump and from which the water is removed, is withdrawn from the liquid of the water removal solvent, and then the attached water removal solvent is removed (dried). Drying may be carried out in the dipping sump or may be carried out outside the dipping sump. Removal of the water removal solvent attached to the article is preferably carried out when the article passes by the cooling pipe at an upper portion of the dipping sump. If the water removal solvent attached to the article is removed by evaporation at a point where there is no vapor of the water removal solvent, the temperature of the article tends to be decreased by the heat of evaporation, and a phenomenon such as condensation of moisture in the air may occur. For example, in a case where the heat capacity of the article is small and the surrounding temperature is not sufficiently high, the temperature of the article is likely to be decreased due to evaporation of the water removal solvent. Consequently, if the temperature at the surface of the article becomes lower than the ambient temperature, there may be a phenomenon such that moisture in the air will be condensed, or the water removal solvent attached to the surface of the article will absorb moisture in the atmosphere before it is evaporated, whereby stains may sometimes be formed on the surface of the article. Accordingly, it is preferred to heat the article to a temperature of the boiling point of the water removal solvent in the vapor of the water removal solvent.

In a case where the article is dried outside the dipping sump, transfer of the article from the dipping sump to the drying zone, is preferably carried out in vapor of the water removal solvent in order to prevent partial drying during the transfer or to prevent a cause for formation of stains e.g. by absorption of ambient moisture in the water removal solvent attached to the article. The atmosphere in the transfer and further, the drying zone, are preferably an atmosphere of vapor of the water removal solvent, e.g. the water removal solvent sent out of the dipping sump, the water removal solvent after the water separation, or a new water removal solvent containing no water. Further, it is possible to use a solvent of a type different from the water removal solvent stored in the dipping sump to form an atmosphere of vapor to the drying zone.

In the present invention, removal (drying) of the water removal solvent attached to the article is preferably carried out beside the cooling pipe 3 above the vapor zone in the dipping sump. The vapor zone in the dipping sump is formed, as shown in FIG. 1 for example, between the liquid surface of the water removal solvent in a boiling state and a position where the cooling means is present. In order to heat the article to the boiling point of the water removal solvent in the vapor zone 8, it is preferred to adjust the thickness of the vapor zone to be a sufficient thickness in accordance with the size and the shape of the article. If the thickness of the vapor zone is insufficient or if there is no vapor zone, stains may be formed on the article. The article heated to the boiling temperature of the water removal solvent in the vapor zone is taken out from the vapor zone 8 and is easily and immediately in the dried state.

### EXAMPLES

Now, the present invention will be described in further detail with reference to Examples. A test of cleaning to remove water was carried out in Examples 1 to 5 using an apparatus shown in FIG. 1. This apparatus mainly comprises a dipping sump 1 equipped with a heater 7 to carry out a dipping step, and a water separation sump 9 to carry out specific gravity separation of water from a water removal solvent, and the capacity of the dipping sump 1 is 18 L, and the capacity of the water separation sump 9 is 18 L.

A water removal solvent 2 is evaporated by heating by means of the heater 7, and the water removal solvent in an amount equal to that of the water removal solvent decreased from the dipping sump 1 is sent to the dipping sump 1 from a water separation sump 10. The vapor of the water removal solvent containing the water brought by an article is condensed by a cooling pipe 3 and is sent to the water separation sump 9 through a trough 4.

The water removal solvent 2 in the dipping sump 1 was brought to a boiling state by supplying electric current to the heater 7 in the dipping sump 1. Further, by controlling the electric current supplied to the heater 7, the circulating time of the water removal solvent was adjusted to 1 hour.

The water concentrations of the water removal solvent in the dipping sump 1 and the water removal solvent obtained by condensing the vapor of the water removal solvent in the dipping sump 1 were measured by a Karl Fischer moisture content measuring apparatus.

### Example 1

A test of drying by removal of water was carried out by using as a water removal solvent ASAHIKLIN AE-3100E (an azeotropic mixture of hydrofluoroether and ethanol manufactured by Asahi Glass Company, Limited, 1,1,2,2-tetrafluoroethyl-2,2,2-trifluoroethyl ether (94)/ethanol (6), boiling point: 54° C.) and by using as an article a #100 stainless mesh (5 cm×5 cm) which had been preliminarily well cleaned and dipped in water.

First, the article was dipped in AE-3100E at the boiling point, and water was removed for 1 minute. On that occasion, no suspension in the dipping sump was observed. Then, vapor cleaning was carried out in a vapor zone of AE-3100E for 30 seconds, and then the drying state of the withdrawn article and the formation of stains were visually confirmed. The stainless mesh after the vapor cleaning was well dried, and favorable drying property by removal of water was observed.

### Example 2

The test of drying by removal of water was carried out in the same manner as in Example 1 except that as the article, a glass plate (5 cm×5 cm) which had been preliminarily well cleaned and dipped in water was used. No suspension in the dipping sump was observed, the glass plate after vapor drying was well dried, and favorable drying property by removal of water was observed.

### Example 3

The test of drying by removal of water was carried out in the same manner as in Example 1 except that as the water removal solvent, AC-2220 (azeotropic mixture of hydrofluorocarbon and ethanol manufactured by Asahi Glass Company, Limited, 1,1,1,2,2,3,3,4,4,5,5,6,6-tridecafluorohexane (91)/ethanol (9), boiling point: 61° C.) was used. No suspension in the dipping sump was observed, the stainless mesh after the vapor drying was well dried, and favorable drying property by removal of water was observed.

### Example 4

The test of drying by removal of water was carried out in the same manner as in Example 2 except that as the water removal solvent, AC-2220 was used. No suspension in the dipping sump was observed, the glass plate after the vapor drying was well dried, and favorable drying property by removal of water was observed.

### Example 5

The same drying by removal of water as in Example 1 was repeatedly carried out 40 times using ASAHIKLIN AE-3100E as the water removal solvent and using a glass plate (5 cm×5 cm) which had been preliminarily well cleaned and dipped in water as the article. Under conditions where the water concentration in the dipping sump 1 at the time of initiation of the test was the saturated water concentration of the solvent, and drying by removal of water was carried out at a rate of once for every 3 minutes, all the 40 glass plates were well dried after the vapor drying.

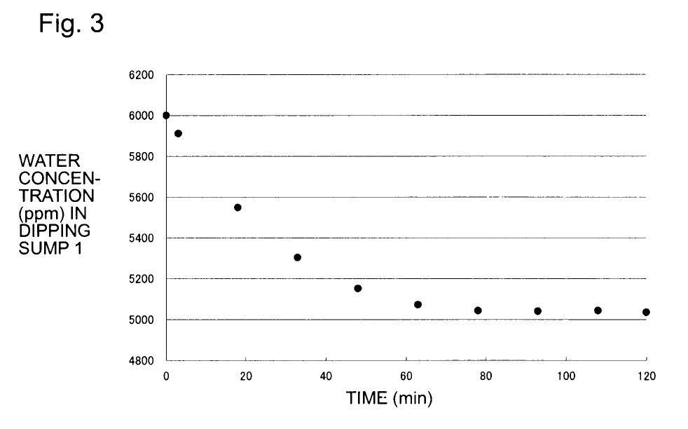

The saturated water concentration at the boiling point of AE-3100E is about 6,000 ppm, and from the water separation sump to the dipping sump, the water removal solvent containing water at a concentration of the saturated water concentration at the liquid temperature in the water separation sump is sent. In FIG. 3 is shown the water concentration change in the dipping sump 1 when the water concentration in the dipping sump at the initiation of the test was 6,000 ppm and 0.3 g of water attached to the glass plate was brought to the dipping sump 1 by drying by removal of water of one glass plate. The water concentration in the dipping sump 1 was at least the saturated water concentration immediately after dipping of the glass plate, whereas the water concentration in AE-3100E in the dipping sump 1 was reduced to the saturated water concentration or below immediately before the next drying by removal of water was carried out. Further, when the test of drying by removal of water on glass plates was repeatedly carried out while the boiling state in the dipping sump was maintained in such a system, the water concentration in AE-3100E in the dipping sump 1 was gradually decreased as shown in FIG. 3. Further, in this test, no white turbidity in the dipping sump 1 was observed. Accordingly, the water could be removed from the article by the water removal solvent in the dipping sump by dissolving the water attached to the article. Further, in the vapor of the water removal solvent during the test, moisture at a level of from about 7,000 to 8,000 ppm, which was at least the saturated water concentration, was always present.

### Comparative Example 1

The same drying by removal of water as in Example 1 is repeatedly carried out by an apparatus for drying by removal of water without water separation sump with an amount of a solvent of 18 L in a dipping sump by using ASAHIKLIN AE-3100E as the water removal solvent. Under conditions where the water concentration in the dipping sump at the initiation of the test was the saturated water concentration of the water removal solvent and drying by removal of water was carried out at a rate of once for every 3 minutes, water remained on the surface of all the glass plates after vapor drying, and drying by removal of water could not be carried out. Further, at a point where the number of dipping of the glass plate exceeded 10 times, the water removal solvent in the dipping sump became cloudy due to presence of a large amount of the water.

### Comparative Example 2

Drying by removal of water from a stainless mesh was carried out by using a cleaning apparatus shown in FIG. 2, by using ASAHIKLIN AE-3100E as a water removal solvent. The cleaning apparatus in FIG. 2 comprises a dipping sump 11 to carry out a dipping step, a water separation sump 12 to carry out a specific gravity separation step, and a vapor generating sump 13 to generate a vapor for an exposure step. The dipping sump 11 is filled with a water removal solvent 14, and has a ultrasonic vibration 15 at its bottom. The capacity of the dipping sump 11 is 18 L, the capacity of the water separation sump 12 is 15 L, and the capacity of the vapor generating sump 13 is from 10 to 20 L. In this apparatus, the water removal solvent in the water separation sump 12 is suctioned by a pump 16 from the bottom of the water separation sump 12 and returned to the dipping sump 1 at a rate of about 5 L/minutes. From the water separation sump 12, the water removal solvent is supplied, whereby the water removal solvent overflows from the dipping sump 11 to a trough 17, and flows into the water separation sump 12 from the bottom of the trough 17. In a case where an article having water attached on its surface is practically dipped in the dipping sump 11, water removed from the article will surface to the liquid surface of the water removal solvent, whereby the liquid overflowing to the trough 17 will be a mixed liquid of the surfaced water and the water removal solvent. At an upper portion of the apparatus, a cooing pipe 18 and a trough 19 to receive the water removal solvent thereby condensed, are provided, and the solvent entered into the trough 19 will be supplied to the water separation sump 12.

Adjustment of the temperature of the water removal solvent in the dipping sump 11 or the water separation sump 12 was carried out by controlling the electric current supplied to a heater 20 or 21. Further, in a case where the exposure step by vapor was to be carried out, an electric current was supplied to a heater 22 of the vapor generating sump 13 to bring the water removal solvent to a boiling state thereby to generate vapor. The vapor generated will be contacted to a cooling pipe 18 and condensed, and the condensed solvent will enter into the trough 19 and then will enter into the water separation sump 12. An article was dipped in AE-3100E at 45° C. in the dipping sump 11 shown in FIG. 2, and ultrasonic waves were applied to carry out removal of water for 1 minute. Then, the article was subjected to vapor cleaning in a vapor zone 23 of AE-3100E for 30 seconds, and then the drying state of the withdrawn article and the formation of stains were visually confirmed. Such an operation was repeatedly carried out with respect to 40 sheets of stainless mesh at a rate of once for every 3 minutes. As a result, the stainless mesh was dried immediately after withdrawn from the dipping sump 11, and no formation of stains was confirmed, immediately after initiation of the cleaning. Whereas, about one and a half hours after initiation of the cleaning, suspension of water in the water removal solvent 14 in the dipping sump 11 started to be observed, and substantially at the same time, stains were formed on the stainless mesh after removal of water.

### Comparative Example 3

The same test of drying by removal of water as in Comparative Example 2 was carried out except that as the article, a glass plate (5 cm×5 cm) which had been preliminarily well cleaned and dipped in water was used. Immediately after initiation of the cleaning, the glass plate was dried immediately after withdrawn from the dipping sump 11, and no formation of stains was observed, but about 2 hours after initiation of the cleaning, suspension of water in the water removal solvent 14 in the dipping sump 11 started to be observed, and substantially at the same time, stains were formed on the glass plate after removal of water.

### INDUSTRIAL APPLICABILITY

The present invention can be applied to drying by removal of water to remove water from the surface of articles such as lenses, components of liquid crystal display devices, electronic parts and precision mechanical parts, in the precision machine industry, the optomechanical industry, the electrical and electronic industry, the plastic industry, etc.

The entire disclosure of Japanese Patent Application No. 2009-027304 filed on Feb. 9, 2009 including specification, claims, drawings and summary is incorporated herein by reference in its entirety.

### REFERENCE SYMBOLS

1, 11: Dipping sump

2, 14: Water removal solvent

3, 18: Cooling pipe,

4, 17, 19: Trough

5: Sending-out pipe

6: Introducing pipe

7, 20, 21, 22: Heater

8, 23: Vapor zone

9, 12: Water separation sump

10: Discharge pipe

13: Vapor generating sump

15: Ultrasonic vibrator

16: Pump

What is claimed is:

1. A process for removing water from an article, which comprises using a fluorinated solvent containing an alcohol as a water removal solvent, dipping an article having water attached in a liquid of the water removal solvent to dissolve or disperse the water in the water removal solvent and remove it from the article, withdrawing the article from the liquid of the water removal solvent and drying it to remove the water from the article having water attached, wherein the water removal solvent in a dipping sump in which the water removal solvent is stored is brought to a boiling state, a cooling means to condense vapor of the water removal solvent is provided at an upper portion of the dipping sump and the condensed water removal solvent is sent out of the dipping sump, a water removal solvent containing water at a concentration less than the saturated water concentration at the boiling temperature of the water removal solvent or containing no water is introduced to the dipping sump, and the article having water attached is dipped in the liquid of the water removal solvent in a boiling state in the dipping sump to remove water, and then the article is withdrawn from the liquid of the water removal solvent.

2. The process for removing water according to claim 1, wherein the amount of the condensed water removal solvent sent out is adjusted so that the water concentration contained in the water removal solvent boiling in the dipping sump is at most the saturated water concentration at the boiling temperature when the article is withdrawn, and the amount of the water removal solvent introduced to the dipping sump is adjusted to be substantially equal to the amount of the water removal solvent sent out.

3. The process for removing water according to claim 1, wherein the water removal solvent sent out of the dipping sump is introduced to a water separation sump, the water is separated from the water removal solvent in the water separation sump by a specific gravity separation method, the separated water is discharged from the water separation sump, and the water removal solvent from which the water is separated is introduced from the water separation sump to the dipping sump as the water removal solvent containing water at a concentration less than the saturated water concentration.

4. The process for removing water according to claim 3, wherein the temperature (T) of the water removal solvent in the water separation sump is T^{b}−10≦T<T^{b} (wherein T^{b} is the boiling point of the water removal solvent).

5. The process for removing water according to claim 1, wherein the fluorinated solvent is a hydrofluoroether or a hydrofluorocarbon.

6. The process for removing water according to claim 1, wherein the fluorinated solvent is at least one hydrofluoroether selected from the group consisting of 1,1,2,2-tetrafluoroethyl-2,2,2-trifluoroethylether, (perfluorobutoxy)methane and (perfluorobutoxy)ethane.

7. The process for removing water according to claim 1, wherein the fluorinated solvent is at least one hydrofluorocarbon selected from the group consisting of 1,1,1,2,2,3,3,4,4,5,5,6,6-tridecafluorohexane, 1,1,1,3,3-pentafluorobutane and 1,1,1,2,2,3,4,5,5,5-decafluoropentane.

8. The process for removing water according to claim 1, wherein the alcohol is a C₁₋₃ alkanol.

9. The process for removing water according to claim 1, wherein the content of the alcohol in the water removal solvent is from 3 to 15 mass %.

10. The process for removing water according to claim 1, wherein the water removal solvent is an azeotropic composition of the alcohol and the fluorinated solvent.
